(19) United States
(12) Patent Application Publication
(10) Pub. No.: US 2002/0119376 A1
(43) Pub. Date: Aug. 29, 2002

(54) Galvanic element having at least one lithium-intercalating electrode

(76) Inventors: Peter Haug, Ellwangen (DE); Peter Birke, Ellwangen (DE); Konrad Holl, Aalen-Dewangen (DE); Dejan Ilic, Ellwangen (DE)

Correspondence Address: Schnader Harrison Segal & Lewis LLP, Suite 3600, 1600 Market Street, Philadelphia, PA, 19103, US

(21) Appl. No.: 10/079,003

(22) Filed: Feb. 20, 2002

(30) Foreign Application Priority Data
Feb. 23, 2001 (DE) DE 101 08 695.4

(51) Int. Cl. H01M 4/66

(52) U.S. Cl. 429/232; 429/245

(57) ABSTRACT

In a galvanic element having at least one lithium-intercalating electrode, whose electrochemically active material is applied onto a metallic output conductor, in the form of foil, the metallic output conductor is provided on its surface with electrochemically deposited crystallites of a second or identical metal, which enlarge the contact area and reduce the contact resistance to the active material. The substrate material is chosen from Al, Cu, V, Ti, Cr, Fe, Ni, Co or alloys of these metals, or from a corrosion-resistant stainless steel, and the deposited metal is chosen from Cu, Vi, Ti, Cr, Fe, Ni, Co, Zn, Sn, In, Sb, Bi, Ag or alloys of these metals. The crystallite size of the electrochemically deposited material is between 1 and 25 μm, preferably between 1 and 10 μm, and a maximum of 10 crystallite layers, preferably 1 to 3 cyrstallite layers, are deposited on the substrate sheet.

### FIELD OF THE INVENTION

The subject mater of the invention is a galvanic element having at least one lithium-intercalating electrode, whose electrochemically active material is applied to a metallic output conductor in the form of foil.

### BACKGROUND

In galvanic elements, the electrical connection between the output conductor electrodes and the electrochemically active substances is the primary governing factor for the functionality of the cell. The most frequent reasons for failure of the cell are contact failures of a purely mechanical nature, or contact failures which are caused by the electrochemical build-up of passivation layers.

Widely differing output conductor materials are known for lithium-intercalating electrodes. Methods for directly pasting the active substances onto perforated sheets or metal meshes composed of aluminum or copper are described in U.S. Pat. No. 6,143,444 A1.

WO 98/20566 discloses output conductor gratings composed of copper or aluminum, which are cleaned, chemically etched and then provided with an adhesion promoter.

U.S. Pat. No. 5,631,104 A1 discloses output conductor sheets composed of aluminum or copper, which are coated with the active substances. In the case of galvanic elements in the form of button cells, the active lithium-intercalating substances are, according to that disclosure, introduced into housing components of the button cell made of stainless steel.

In the electrode production method according to U.S. Pat. No. 5,460,904 A1, a copper sheet, preferably in the form of a metal mesh, for the negative output conductor electrode has any oxide layer present removed by means of dilute sulfuric acid, is then rinsed a number of times, dried, and then provided with a thin polyvinylidene hexafluropropylene layer which is pyrolized for a few seconds at 350° C. Aluminum is used rather than copper as the positive output conductor electrode, and is cleaned in acetone, etched using sodium hydroxide solution, and then provided with a carbon-based primer. The output conductor electrodes thus obtained are connected to the active electrodes by means of a hot lamination method.

In general, metal meshes, with copper on the negative side and aluminum on the positive side, are used as the output conductor materials for producing rechargeable lithium-polymer cells. The production of metal meshes from sheets is complex and, apart from the unavoidable waste, an additional rolling and annealing step is often also required. Furthermore, as stated in particular in U.S. Pat. No. 5,460,904, subsequent costly coatings with what are referred to as “primer” are required, to ensure adequate adhesion of the electrodes on the metal meshes.

It would therefore be quite advantageous to improve the electrical connection between the active materials and the output conductor foil for galvanic elements having lithium-intercalating electrodes.

### SUMMARY OF THE INVENTION

This invention relates to a galvanic element including at least one lithiumintercalating electrode having electrochemically active material applied to a metallic output conductor or a substrate sheet, in the form of foil, wherein the metallic output conductor or substrate sheet has on a surface thereof electrochemically deposited crystallites of a second or substantially identical metal, the crystallites enlarging contact area of the element and reducing contact resistance to the active material.

### BRIEF SUMMARY OF THE DRAWINGS

FIG. 1 is a graph of capacity c versus number of cycles n for bi-cells of the invention.

FIG. 2 is a graph of capacity c versus number of cycles n for bi-cells of the invention.

### DETAILED DESCRIPTION

The substrate material used in accordance with the invention is selected from Al, Cu, V, Ti, Cr, Fe, Ni, Co or alloys of these metals, or from a corrosion-resistant stainless steel, and the deposited metal is selected from Cu, V, Ti, Cr, Fe, Ni, Co, Zn, Sn, In, Sb, Bi, Ag or alloys of these metals.

The crystallite size of the electrochemically deposited material may be between about 1 and about 25 μm, preferably between about 1 and about 10 μm.

The thickness of the substrate sheet is between about 5 and about 50 μm, preferably between about 8 and about 25 μm, with a maximum of 10 crystallite layers, preferably 1 to 3 crystallite layers, being deposited on the sheet.

In the case of a base metal or seminoble metal, the crystallite layer is provided with a corrosion layer, which is benzotriazole or chromatization applied by means of an immersion process. The active electrode material is preferably laminated onto the output conductor foil in the form of a sheet.

The sheets according to the invention can advantageously be used in known Li-ion cells, for example, in cells in which the electrodes are in the form of a winding, but in particular in flat cells that are laminated from a number of layers.

What is referred to as a “bi-cell,” as disclosed in U.S. Pat. No. 5,460,404 A1, is in the general form negative electrode/copper metal mesh/negative electrode, separator, positive electrode/Al metal mesh/positive electrode, separator, negative electrode/copper metal mesh/negative electrode. The design chosen is justified by improved safety in the event of a short circuit and improper opening of such a cell. If only one aluminum metal mesh is formed instead of two, then the load currents are doubled and, in a critical state, they may clearly be sufficient to melt the aluminum locally, and thus to interrupt the contact.

However, if a polyolefin separator, which is known per se, with a shut-down mechanism—in critical situations, the pores of the separator are fused together and the cell resistance rises suddenly—is used instead of an SiO₂-PVDF-HFP-based separator, then the design can be in an inverse form. This has the advantage that the kinetically slower positive electrode and the aluminum, which is a poorer conductor than copper, now have twice the area.

Furthermore, it is necessary to extract the softener as completely as possible during the production of these lithium-polymer cells, as is explained in detail in U.S. Pat. No. 5,460,904 A1. This method step and the penetration of the liquid electrolyte which is also required, associated with its homogeneous distribution, lead to the necessity of using metal meshes as the output conductor materials.

According to the invention, in the design that is the inverse of this, namely positive electrode/Al metal mesh/positive electrode, separator, negative electrode/copper sheet/negative electrode, positive electrode/Al metal mesh/positive electrode an electrode treated according to the invention is used, without any possible extraction step of the plasticizer and to prevent subsequent penetration of a liquid electrolyte.

The advantages resulting from this are major. The connection is formed over a large area, and this is particularly important because inhomogeneities in the negative electrode can provoke polarization, lithium deposition and hence gradual destruction. The electrochemical deposition, in particular of copper crystallites onto a copper sheet, means that no primer is required. Since the primers are generally organically based, they generally make the most contribution to fading performance of a cell. This is particularly true on the negative side, where high lithium activities gradually degrade organic compounds over time, especially at high temperatures. Furthermore, in the past, the primer on the copper side for polymer cells had to be produced in a very costly pyrolysis step, while simple application was sufficient on the aluminum side. From a production engineering point of view, pouring and lamination onto a sheet can be carried out more easily. Production costs, in particular such as stamping processes and waste in the case of metal mesh, are avoided so that the costs for output conductor materials are considerably reduced.

The use of sheets according to the invention is particularly advantageous, especially copper sheets, in a method for producing electrode sheets in which at least two different fluorized polymers are dissolved in a solvent and mixed, without the addition of any plasticizer, swelling agents or electrolyte, just with highly conductive carbon black, whose BET surface area is between that of graphite with a minimized surface area and activated carbon, and with an electrochemically active material with a two-dimensional layer structure and an electronic conductivity of at least about 10⁻⁴ S/cm, into which lithium can be reversibly introduced and removed, and the pasty substance produced is applied to an electrode output conductor or to a substrate sheet, and dried. Positive electrode sheets and negative electrode sheets thus produced are laminated onto a separator, the stack is impregnated with a liquid organic electrolyte, and a galvanic element formed.

Vinylidene fluoride and hexafluoropropylene are used, in particular, as polymers and N-methylpyrrolidin-2-one or acetone is used as the solvent.

A material from the group of ternary (Li—Me1—O) or quaternary (Li—Me1—Me2—O) lithium transition metal oxides, with Me 1 and Me 2 being chosen from the group Ti, V, Cr, Fe, Mn, Ni and Co, is used as the electrochemically active material for a positive electrode sheet, and the compound may additionally contain up to about 15 percent by atomic weight of Mg, Al, N or F to stabilize the structure. A graphitized carbon modification is used as the electrochemically active material for the negative electrode sheet. A method such as this is described in German Patent Application P 10104988.9, for example.

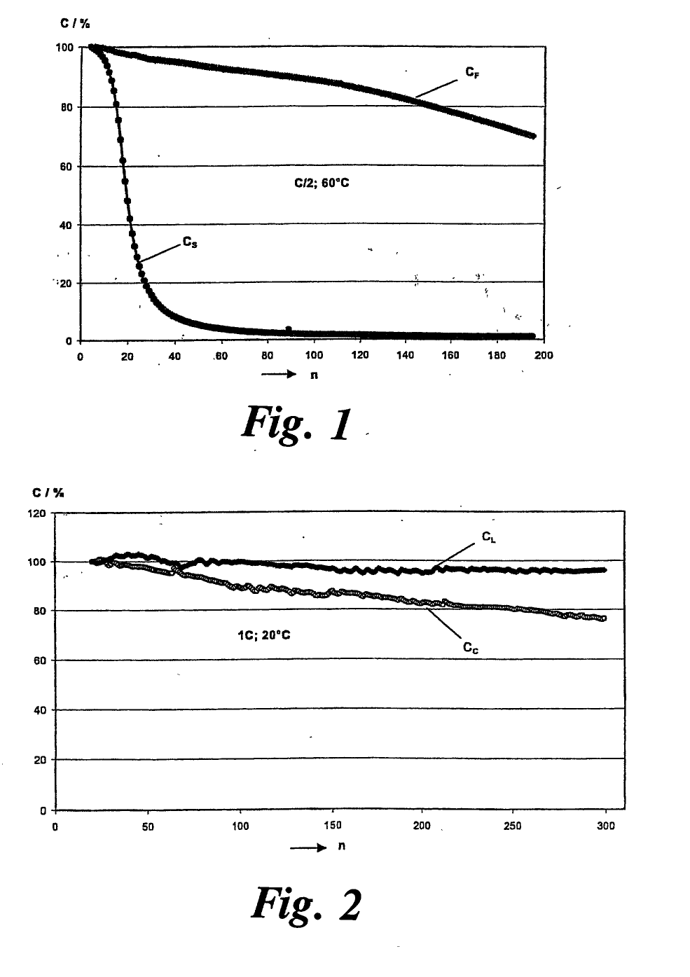

The electrochemical deposition according to the invention of, in particular, copper crystallites onto a copper sheet results in a considerable surface area and connection advantage, which makes it possible to avoid using a primer for lithium-polymer cells and allows the use of polymers, which are easy to process, in the electrodes, since they no longer need to guarantee the adhesion on the bare sheet as well. Copper metal meshes in the connection currently fail, especially at high temperatures (60° C.). This leads to detachment of the active material from the output conductor electrode, which has a negative influence on cycle stability (see FIG. 1). This is due not only to a reaction of the primer in the case of high lithium activities, but also to the asymmetric current distribution caused by the metal mesh.

### EXAMPLE 1

250 ml of acetone together with 27.8 g of PVDF-HFP (Powerflex, Elf Atochem) were placed in a 500 ml Erlenmeyer flash, and the mixture heated to 42° C. in a water bath, to produce the negative electrode. Stirring was carried out using an IKA mixer until the polymer dissolved completely. 6.2 g of conductive carbon black (Super P, Sedema) and 275.3 g of spherical graphite (MCMB 25-28, Osaka Gas) were then added, and the mixture stirred for 2 h. The rotation level was in this case set to be sufficiently strong to be just below the level at which air was stirred in.

The same procedure was used for the positive electrode, with 24.8 g of PVDF-HFP (Powerflex, Elf Atochem), 2.6 g of conductive carbon black (Super P, Sedema), 2.6 g of graphite (KS 6, Timcal) as a conductivity improver and 276.2 g of lithium cobalt oxide (FMC) in this case being added to 250 ml of acetone.

The negative electrode and positive electrode were produced by means of tape casting with a mass per unit area of 19-21 g/cm². Mylar (polyester sheet) was used as the substrate sheet. The negative electrode was then laminated, at a temperature of 160° C., onto a chromatized copper sheet whose surface had been treated according to the invention (surface treatment by electrochemical deposition of copper crystallites). The positive electrode sheet was laminated onto aluminum metal mesh in the same way. Negative electrodes and positive electrodes were stamped out of the strips laminated in this way, and laminated to form bi-cells (positive electrode/Al metal mesh/positive electrode, separator, negative electrode/copper sheet/negative electrode, positive electrode/Al metal mesh/positive electrode). The separator was provided, for example, with three layers (PP/PE/PP) and a thin PVDF-HFP layer. The separator was first of all laminated onto both sides of the negative electrode at 130° C., and the upper and lower positive electrodes were then laminated on in a second lamination step, with the same parameters.

In parallel with this, a cell was produced with a copper metal mesh according to U.S. Pat. No. 5,460,904. Stacks of 6 bi-cells were produced with both variants.

FIG. 1 shows the relationship between the capacity C and the number of cycles n for the bi-cells according to the invention with copper sheet as the output conductor (C_{F}) and for bi-cells according to U.S. Pat. No. 5,460,904 with copper metal mesh as the output conductor (C_{S}). The measurements were carried out at 60° C. and at a load of C/2 (charge 1C/3 h/60° C. up to 4.2 V, discharge 0.5 C/60° C. down to 3.0 V).

### EXAMPLE 2

A substance for the negative electrode was produced in the same way as in Example 1 and, instead of being applied to a polyester sheet, was wiped directly onto the copper output conductor electrode that had been surface-treated in accordance with the invention (surface treatment by means of electrochemical deposition of copper crystallites). The solvent was allowed to vaporize, and the electrode adhered very well to the output conductor electrode once it had dried. The variant produced comprised one bi-cell, instead of six.

### EXAMPLE 3

In order to produce the negative electrode, 1 l of acetone was placed together with 123.7 g of PVDF-HFP (Powerflex, Elf Atochem) in a 2 l Erlenmeyer flash, and the mixture heated to 42° C. in a water bath. The mixture was stirred with an IKA mixer until the polymer dissolved completely. 261.2 g of dibutyl phthalate, 27.5 g of conductive carbon black (Super P, Sedema) and 962 g of spherical graphite (MCMB 25-28, Osaka Gas) were then added, and the mixture stirred for 2 h. The rotation level was in this case set to be sufficiently strong to be just below the level at which air was stirred in.

The same procedure was used for the positive electrode, with 99.0 g of PVDF-HFP (Powerflex, Elf Atochem), 165.1 g of dibutyl phthalate, 66.0 g of conductive carbon black (Super P, Sedema) as a conductivity improver and 939.7 g of lithium cobalt oxide (FMC) in this case being added to 1.5 l of acetone.

The negative electrode and positive electrode were produced by means of tape casting with a mass per unit area of 19-21 g/cm². Mylar (polyester sheet) was used as the substrate sheet. The negative electrode was then laminated, at a temperature of 130° C., onto a chromatized copper sheet whose surface had been treated according to the invention (surface treatment by electrochemical deposition of copper crystallites). The positive electrode sheet was laminated onto aluminum metal mesh in the same way. Negative electrodes and positive electrodes were stamped out of the strips laminated in this way, and laminated to form bi-cells (positive electrode/aluminum metal mesh/positive electrode, separator, negative electrode/copper sheet/negative electrode, positive electrode/Al metal mesh/positive electrode). The separator was provided, for example, with three layers (PP/PE/PP) and with a thin PVDF-HFP layer. The separator was first of all laminated onto both sides of the negative electrode at 120° C., and the upper and lower positive electrodes then laminated in a second lamination step, with the same parameters. The dibutyl phthalate was extracted three times using n-hexane before the cells were partially packaged, vacuum-dried for 16 h at 80° C., and then activated by means of a liquid electrolyte. Diethyl ether can also be used for extraction of the dibutyl phthalate.

A nickel sheet can also be used as an alternative to the copper sheet, and the deposition of silver crystallites instead of copper or nickel crystallites has been found to be particularly advantageous for the connection.

FIG. 2 shows a direct comparison of the capacity C as a %, as a function of the number of cycles n for a 1 C load and at room temperature; C_{C} for a negative electrode substance (Example 2) applied wet-chemically directly onto copper sheet, C_{L} for electrode sheets laminated onto copper sheet (Example 3) (charge 1C/3 h/20° C. up to 4.2 V, discharge 1C/20° C. down to 3.0 V).

What is claimed is:

1. A galvanic element comprising at least one lithium-intercalating electrode having electrochemically active material applied to a metallic output conductor or a substrate sheet, in the form of foil, wherein the metallic output conductor or substrate sheet has on a surface thereof electrochemically deposited crystallites of a second or substantially identical metal, the crystallites enlarging contact area of the element and reducing contact resistance to the active material.

2. The galvanic element of claim 1, wherein the metallic output conductor or substrate sheet is selected from a component of the group consisting of Al, Cu, V, Ti, Cr, Fe, Ni, Co, alloys thereof and corrosion-resistant stainless steel.

3. The galvanic element of claim 1, wherein the electrochemically active material is selected from the group consisting of Cu, V, Ti, Cr, Fe, Ni, Co, Zn, Sn, In, Sb, Bi, Ag and alloys thereof.

4. The galvanic element of claim 1, wherein crystallite size of the electrochemically is between about 1 and about 25 μm, preferably between 1 and 10 μm.

5. The galvanic element of claim 1, wherein the thickness of the metallic output conductor or substrate sheet is between about 5 and about 50 μm.

6. The galvanic element of claim 1, wherein the thickness of the metallic output conductor or substrate sheet is between about 8 and about 25 μm.

7. The galvanic element of claim 1, wherein a maximum of 10 crystallite layers, are deposited on the metallic output conductor or substrate sheet.

8. The galvanic element of claim 1, wherein a maximum of 1 to 3 crystallite layers, are deposited on the metallic output conductor or substrate sheet.

9. The galvanic element of claim 1, wherein the crystallites are provided with a corrosion layer made from benzotriazole or chromatization is applied by immersion.

10. The galvanic element of claim 1, wherein the electrochemically active material is laminated onto the metallic output conductor or substrate sheet in the form of a sheet.
